(19) United States
(12) Patent Application Publication
(10) Pub. No.: US 2010/0062745 A1
(43) Pub. Date: Mar. 11, 2010

(54) MESSAGING APPARTUS AND METHOD

(75) Inventor: Matthew Silk, San Francisco, CA (US)

Correspondence Address: PERKINS COIE LLP, P.O. BOX 1208, SEATTLE, WA, 98111-1208, US

(73) Assignee: Waterfall Mobile, Inc., San Francisco, CA (US)

(21) Appl. No.: 12/299,750

(22) PCT Filed: May 10, 2007
(86) PCT No.: PCT/US2007/011394

§ 371 Date: Nov. 16, 2009

Related U.S. Application Data
(60) Provisional application No. 60/800,276, filed on May 12, 2006.

(51) Int. Cl. H04M 1/66; H04W 4/12; H04M 3/42

(52) U.S. Cl. 455/411; 455/466; 455/414.1

(57) ABSTRACT

Methods and systems are described which are used to facilitate the retrieval of content associated with keywords. A message platform is provided where users may register keywords and generate content corresponding to the keywords. The content associated with a keyword may subsequently be retrieved remotely by sending the keyword via a communication device such as a mobile phone, a PDA, an IM client, or the Internet. Advantages of the invention include the provision of a centralized platform from which content may be remotely accessible using a variety of communication venues.

### BACKGROUND

Consumer demand for mobile communication devices has risen exponentially in the recent years. In response, a variety of mobile communication devices offering sophisticated applications are now available on the marketplace. For example, some models of mobile phones have Short Message Service (SMS) as well as e-mail capabilities to enhance user experience.

SMS allows users to communicate by sending and receiving messages via wireless communication devices. In one common application of SMS, a user may send a message from his/her wireless communication device to a second wireless communication device, and the user of the second device may respond by sending a response to the message. This application facilitates communication on a one-on-one basis but may be inadequate if a user wants to send a message to a number of communication devices. For example, if a user wants to notify a number of friends and family members that the user is hosting a party, it is inconvenient to send individual invitations describing details for the party. This is particularly true where the user must type on compact wireless devices that do not include full keyboards. Within the commercial context, a vendor may wish to send promotional material to its consumers such as advertisements or special offers. Traditional one-on-one mobile structure does not offer vendors easy broadcasting capabilities through mobile communication devices.

Accordingly, there is a need for a centralized platform from which users may generate content that is accessible from remote sources including mobile communication devices.

The following embodiments and aspects thereof are described and illustrated in conjunction with systems, tools, and methods that are meant to be exemplary and illustrative, not limiting in scope. In various embodiments, one or more problems in the prior art have been reduced or eliminated, while other embodiments are directed to other improvements.

### SUMMARY

The present invention relates to the field of mobile messaging. In particular, the invention relates to a messaging platform that allows remote retrieval of user-generated content.

In one exemplary embodiment of the invention, a user registers a keyword with a mobile messaging platform and generates content associated with the keyword. The content associated with the keyword may then be retrieved remotely using mobile communication devices such as a mobile phone or a personal digital assistant (PDA).

The proposed system and method can offer, among other advantages, a self-service platform for consumers and businesses utilizing open protocols of U.S. and international communication carriers. Advantageously, the proposed systems and methods allow users to design mobile applications using a variety of interfaces, without fixed costs or interaction with carriers.

### BRIEF DESCRIPTION OF THE DRAWINGS

Embodiments of the inventions are illustrated in the figures. However, the embodiments and figures are illustrative rather than limiting; they provide examples of the invention.

FIG. 1 depicts a flowchart of an example of a method for messaging using keywords.

FIG. 2 depicts a flowchart of an example of a method for accessing content associated with keywords.

FIG. 3 depicts a flowchart of an example of a method for obtaining a keyword.

FIG. 4 depicts a flowchart of an example of a method for manipulating functional aspects of a keyword.

FIG. 5 depicts a flowchart of an example of a method for receiving content associated with a keyword.

FIG. 6 depicts a flowchart of an example of a method for sending content associated with a keyword.

FIG. 7 depicts a networked system for use in an embodiment.

### DETAILED DESCRIPTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments of the invention.

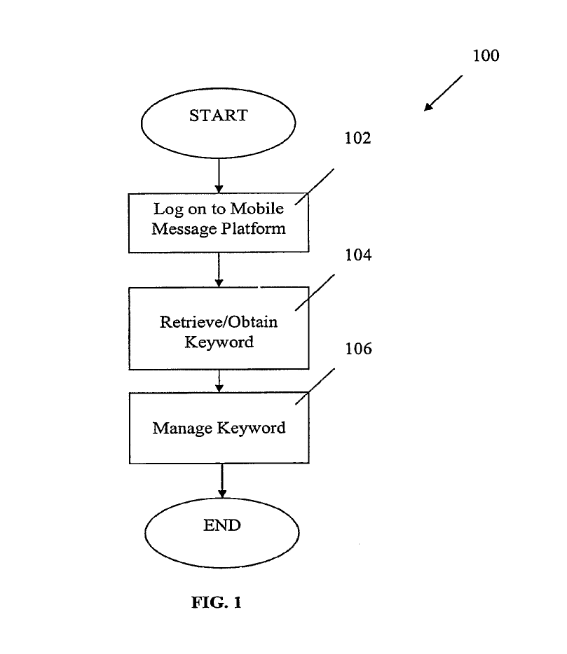

FIG. 1 depicts a flowchart 100 of an example of a method for messaging using keywords. The method in flowchart 100 allows users to create and manage content associated with one or more keywords. A keyword can be any alphanumeric string that a user chooses. In one embodiment, the keyword is limited by a maximum character count. The content can be in any multimedia format including, but not limited to, text, graphic, video, or audio. Users may obtain keywords and become owners of the obtained keywords. A keyword owner may choose any content to associate with a keyword the owner has obtained. For example, and not limitation, a keyword owner may associate a keyword with a promotion, an advertisement, a schedule, a notice and the like.

In the example of FIG. 1, the flowchart starts at module 102 where a user logs onto a mobile message platform. In one embodiment, the mobile message platform is a convenient and/or known website that hosts a web platform allowing a user to utilize keyword functionalities described later.

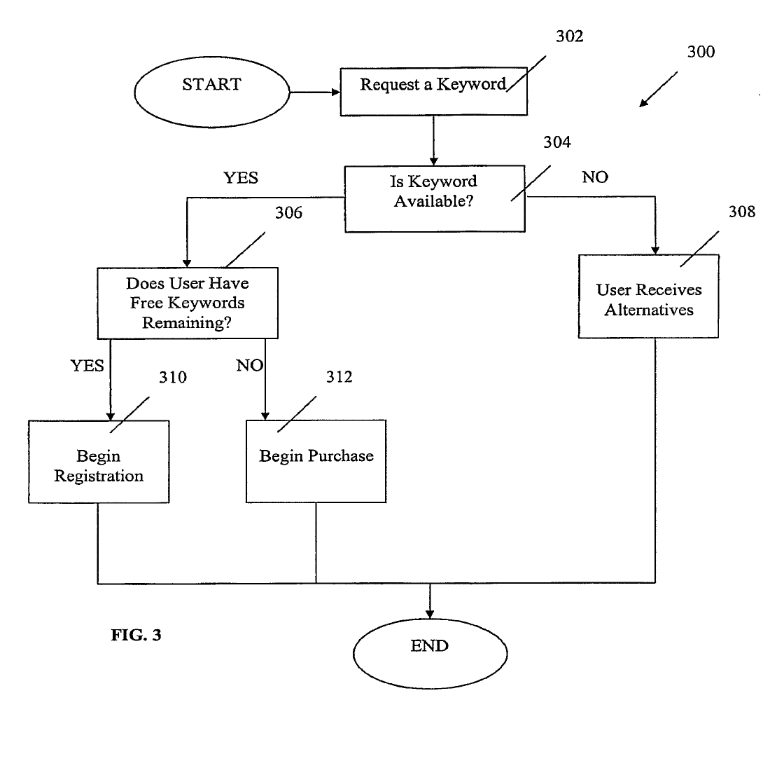

In the example of FIG. 1, the flowchart 100 continues at module 104 where a keyword is retrieved or otherwise obtained. In one embodiment where the user has registered or otherwise obtained one or more keywords, the user is the keyword owner of these one or more keywords and may retrieve any of these keywords to access the content and management functions associated with the keywords. The keyword content and associated management functions can be retrieved using any convenient and/or known technique, including, by way of example and not limitation, searching for the keyword using a search engine and/or search application, selecting from a list of keywords displayed upon a log-on session with an interface capable of implementing keyword functionalities, automatically retrieving a keyword as determined by preference information, and the like. Alternatively, where the user has not registered or otherwise obtained a keyword, the user can register or otherwise obtain one or more keywords to access content and management functions associated with the one or more keywords. The process for obtaining a keyword is described later with reference to FIG. 3.

In the example of FIG. 1, the flowchart 100 continues at module 106 where the retrieved or obtained keyword is managed. The keyword can be managed using any known and/or convenient keyword functionalities. For example, but not limitation, a user can delete a keyword, add description associated with a keyword, select a category under which to classify a keyword, set an expiration date for a keyword, associate a usage fee with a keyword, restrict access to a keyword, and the like. In one embodiment, a keyword can be subscribed to and the subscribers can elect to receive scheduled one-time or interval deliveries of content associated with the keyword. Further, the interface for managing the keywords can be implemented in any convenient and/or known format, including formats capable of being displayed and/or interacted with on the Internet, mobile phone, PDA, computer, and/or any type of device with or without a central processing unit.

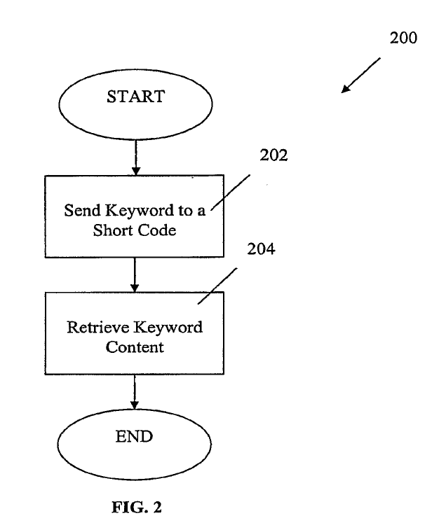

FIG. 2 depicts a flowchart 200 of an example of a method for accessing content associated with a keyword. FIG. 2 illustrates a process for providing a keyword as a text message and receiving content associated with the keyword.

In the example of FIG. 2, the flowchart 200 begins at module 202 where the keyword is provided as a text message to a shortcode. A shortcode is a special, shortened telephone number typically used to address SMS messages or Multimedia Message Service (MMS) messages from mobile devices. In other embodiments, the keyword can be sent to any application that allows a user to retrieve content associated with the keyword. Further, the keyword can be sent using any device capable of communication, including, by way of example and not limitation the Internet, mobile phones, PDAs, or IM clients.

In the example of FIG. 2, the flowchart 200 continues at module 204 where keyword content is received in response to sending the keyword to a shortcode in module 202. In one embodiment, the keyword can be sent to the shortcode by a mobile phone and the keyword content is then received by a mobile phone. In another embodiment, the keyword can be sent to the shortcode by a different device than the device where the keyword content is received. In other embodiments, any combination of devices can be utilized to send the keyword and receive keyword content, provided that such devices are capable of communicating with a system implementing the keyword functionalities. For example, and not limitation, the keyword may be sent from and the keyword content may be received on a web interface, mobile phone, PDA, IM client, and the like.

FIG. 3 depicts a flowchart 300 of an example of a method for obtaining a keyword. A keyword may be obtained using any convenient and/or known method, including by searching for a keyword, registering a keyword, selecting an add-keyword function, or sending a SMS request to search or add a keyword to a system that is capable of implementing keyword functionalities. In the example of FIG. 3, the flowchart 300 starts at module 302 where a request to obtain a keyword is made. A keyword may be requested using any convenient and/or known method including a search keyword function, a register keyword function, an add keyword function, and the like.

In the example of FIG. 3, the flowchart 300 continues at decision point 304 where it is determined whether the requested keyword is available. The keyword can be determined as available or unavailable using any known and/or convenient technique. For example, and not limitation, a database containing keywords can be queried, a list of available keywords can be maintained, a list of unavailable keywords can be maintained, a coding system representing the keywords can be implemented and utilized to make the determination, a third party can maintain a list of the available keywords, etc. If a keyword is available (304—Yes), the flowchart 300 continues at decision point 306. If a keyword is unavailable (304—No), the flowchart continues at decision point 308. A keyword may be unavailable for one or more of numerous reasons. For example, another user may already own the keyword or the keyword is a registered trademark belonging to another party.

Assuming the requested keyword is available (304—Yes), the flowchart continues at decision point 306 where it is determined whether the user has any free keywords left. In one embodiment, a user may obtain a predetermined number of keywords at no cost and a counter equaling the predetermined number is decremented by one each time the user obtains a keyword. Once the counter reaches zero, the user is notified that there are no free keywords left when the user attempts to obtain another keyword. In other embodiments, any convenient and/or known technique can be used that allows the system to determine whether the user has remaining free keywords.

If the user has free keywords (306—Yes), registration of the keyword begins. Keyword registration may be conducted in any convenient and/or known manner, including by way of example, associating the keyword with user profile information such as user name, email address, phone number, and the like. In one embodiment, the requested keyword may be temporarily locked and inaccessible during the registration process. In one embodiment, the registration process includes a query for content associated with the keyword. In one embodiment, the user may choose to register without adding any content and receive reminders to add content in subsequent login sessions. In one embodiment, if the requested keyword is determined as a trademark, the registration process commences only when the user is verified to have rights to the trademark. The keyword can be determined to be a trademark using any known and/or convenient technique. For example, and not limitation, a database containing trademarks can be queried or a list of trademarks can be maintained locally or remotely. The user may be verified as having rights to the trademark through any convenient and/or known methods including, but not limited to, manual verification.

Returning now to decision point 306, if the user does not have any free keywords left (306—No), the purchasing module 312 prompts the user to purchase the keyword. The purchase module can proceed in any convenient and/or known manner, including by way of example, receiving the user's credit card number, PayPal account, or the like. In one embodiment, the user may select from one or more previously registered payment methods including, but not limited to, credit card information on file, banking account access information, accumulated credit, and the like. In another embodiment, the user has the option to add a new payment method.

Assuming the keyword is not available (304—No), the flowchart 300 continues at decision point 308 where the requesting user is notified and presented with alternatives. In one embodiment, the requesting user may receive suggestions including, but not limited to, available keywords that include the requested keyword and alphanumeric prefixes or postfixes. In other embodiments, the requesting user may have the option to subscribe to, trade, or purchase the keyword. In one embodiment, the requesting user may receive the keyword owner's contact information to procure a trade or purchase. In other embodiments, the keyword owner can be notified of the requesting user's intent to purchase and/or trade the keyword and receive the requesting user's contact information. If the requesting user wishes to subscribe to the keyword, the requesting user can be presented with a suitable interface that facilitates the transaction.

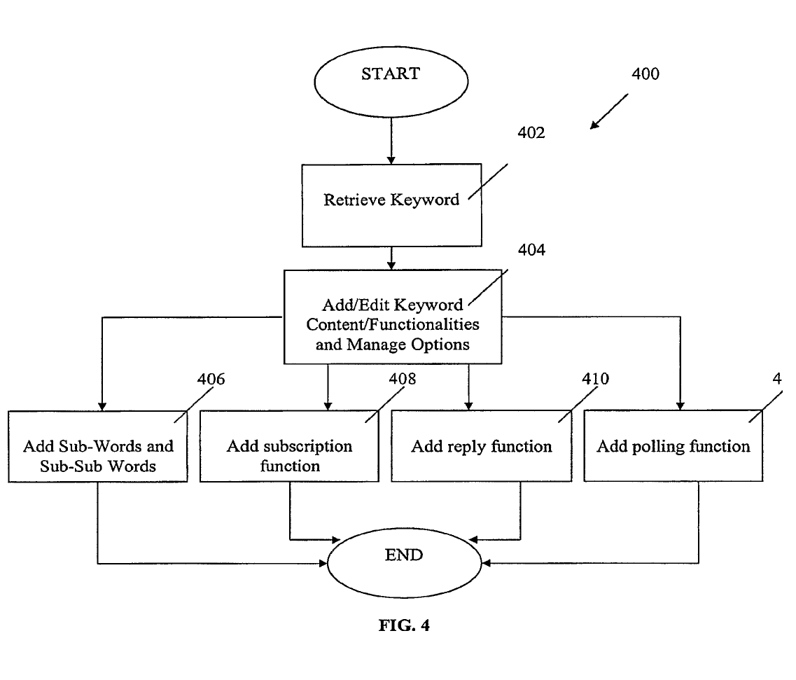

FIG. 4 depicts a flowchart 400 of an example of a method for manipulating functional aspects of a keyword. FIG. 4 illustrates the process for associating various attributes and/or functionalities to the keyword. In the example of FIG. 4, the flowchart 400 starts at module 402 where a user retrieves a keyword. The interface for retrieving the keywords can be implemented in any convenient and/or known format, including formats capable of being displayed and/or interacted with on the Internet, mobile phone, PDA, computer, and/or any type of communication device with or without a central processing unit. The keyword can be retrieved using any convenient and/or known method, including, but not limited to searching for a keyword or registering a keyword with an interface capable of implementing keyword functionalities.

In the example of FIG. 4, the flowchart 400 continues at module 404 where a user can add/edit content and functionalities associated with the keyword. The user can add/edit the content and functionalities using any convenient and/or known interface and/or technique. Further, the interface for retrieving the keywords can be implemented in any convenient and/or known format, including formats capable of being displayed and/or interacted with on the Internet, mobile phone, PDA, computer, and/or any type of device with or without a central processing unit. For example, and not limitation, the user can add text content by inserting text into a dialog box that is available over the Internet. Subsequently, the content associated with the keyword can be provided to whomever sends the keyword as a text message to an appropriate shortcode. In other embodiments, the keyword content can be sent to any system that allows a user to utilize keyword functionalities to retrieve keyword content. Further, the keyword content can be sent using any communication device, including, by way of example and not limitation, mobile phones, PDAs, or IM clients.

In the example of FIG. 4, the flowchart 400 continues to four exemplary content and functionality management options denoted as modules 406, 408, 410, and 412 respectively.

The module 406 illustrates a function that allows a keyword owner to add sub-words and sub-sub-words to the keyword. A sub-word is a secondary word associated with a keyword that can be part of the content. In one embodiment, a sub-word may be used to provide sub-categories within the context of the keyword. For example, but not limitation, a user who has a yoga studio and owns the keyword “yoga” may also add a sub-word “instructors” that describes the background and contact information of the instructors currently working at the studio. The sub-word can be added using any convenient and/or known interface capable of associating a sub-word with a keyword and/or the text content of a keyword. In one embodiment, the user can add sub-words and associated content on a web platform. In another embodiment, the user can add the sub-words and associated content separately using a text message and/or any other communication method.

In module 406, if a user elects to add sub-words to the keyword, the user may also add sub-sub-words associated with the sub-words. A sub-sub-word is a tertiary word associated with a sub-word. In one embodiment, a sub-sub-word may be used to provide sub-categories within the context of a sub-word. For instance, in the example above where a user has a yoga studio and owns the keyword “yoga” and the sub-word “instructors,” the user may also add a sub-sub-word “schedule” associated with the sub-word “instructors” that describes the current course schedule for each instructor. The sub-sub-word can be added using any convenient and/or known interface capable of associating a sub-sub-word with a sub-word and/or the text content of a sub-word. In one embodiment, a user can add sub-sub-words and associated content on a web platform. In another embodiment, the user can add the sub-sub-words and associated content separately using a text message and/or any other communication method.

Additionally, the keyword retrieved in module 402 as well as the sub-words and the sub-sub-words added in module 406, can be managed using any known and/or convenient technique including, but not limited to, setting an expiration date, setting a usage fee, restricting access, sharing rights, scheduling, and/or any other preference settings. Further, the interface for managing the keyword, the sub-words, and the sub-sub-words can be in any convenient and/or known format, including formats capable of being displayed and/or interacted with on the Internet, mobile phone, PDA, computer, and/or any type of device having a central processing unit.

The example of FIG. 4 also illustrates other management options including a subscription function in module 408, a reply function in module 410, and a polling function in module 412. The subscription function module 408 allows keyword owners to add a subscription function to a keyword. In one embodiment, users may subscribe to a keyword having the subscription function and retrieve the content associated with the keyword, provided the users pay usage fees at regular intervals. In another embodiment, users may obtain the content associated with a keyword having the subscription function for a one-time usage fee. The reply function module 410 allows keyword owners to add a reply function to a keyword. In one embodiment, users may use the reply function associated with a keyword to send comments or replies in response to the content associated with the keyword. The polling function module 412 allows a keyword owner to add a polling function to a keyword. In one embodiment, users can use the polling function associated with a keyword to vote in response to the content associated with the keyword.

The example of FIG. 4 is an illustrative embodiment and is not intended to be limiting. One skilled in the field will readily understand that the four management options shown in FIG. 4 are exemplary and more or fewer options may be implemented. For example, the three word types (i.e. keyword, sub-word, and sub-sub-word) described in FIG. 4 are illustrative of the hierarchical nature of messaging keywords and additional or fewer levels of hierarchy may be available depending on user preference. Further, the content associated with a keyword, a sub-keyword, or a sub-sub-keyword may be in any multimedia format including, but not limited to, text, graphics, video, or audio. A user may select the content format with any convenient and/or known method including, but not limited to, using a pull-down menu to select a content format. In one embodiment, text is set as the default format and the user may choose an alternative format such as graphics, video, or audio. In one embodiment, if the user chooses a format other than text, the user must upload content in the selected format such as a photo, a video, or an audio file. In one embodiment, the quality and/or validity of the content is checked. For example, but not limitation, text content may be filtered for obscene or inappropriate language and the format for photo, video, or audio content may be verified for validity. An exhaustive list of all combinations and permutations of embodiments has not been attempted here but one skilled in the relevant art will recognize alternative embodiments based on the method described above.

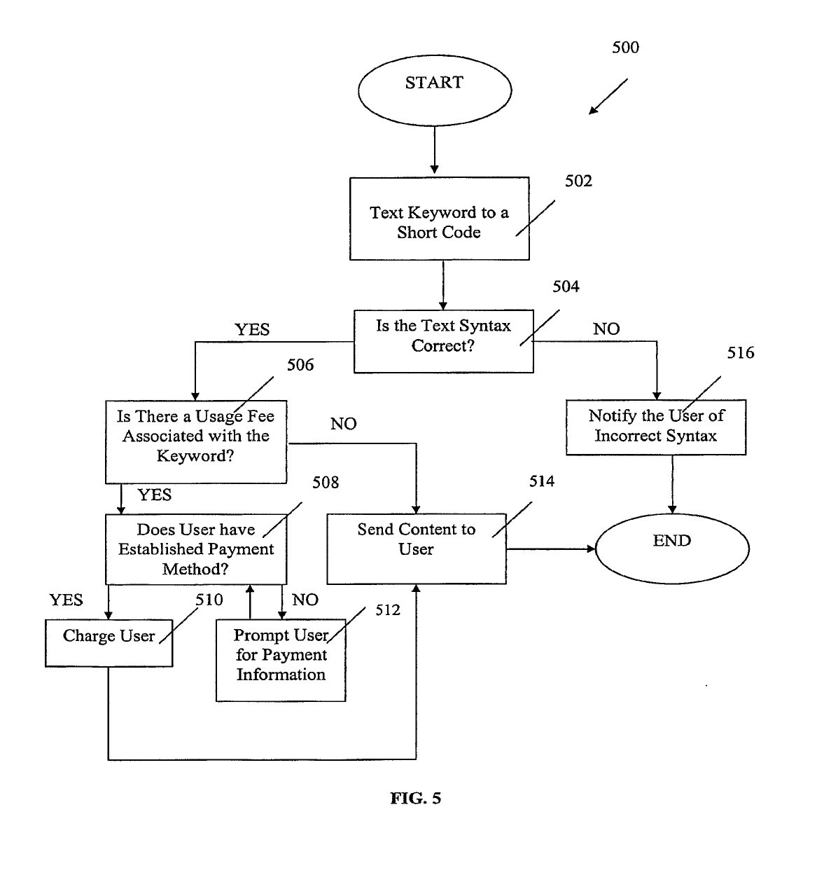

FIG. 5 depicts a flowchart 500 of an example of a method for receiving content associated with a keyword. The flowchart 500 illustrates a method for receiving content associated with a keyword on a communication device and charging a usage fee for receiving the content. The communication device is any device capable of interacting with a system implementing the keyword functionalities including, by way of example and not limitation, the Internet, mobile phones, PDAs, or IM clients.

In the example of FIG. 5, the flowchart 500 begins at module 502 where a user provides a keyword to an appropriate shortcode. In other embodiments, the keyword can be sent to any application that allows a user to utilize keyword functionalities to retrieve keyword content. Further, the keyword can be sent using any communication device, including, by way of example and not limitation, the Internet, mobile phones, PDAs, or IM clients.

In the example of FIG. 5, the flowchart 500 continues at decision point 504 where it is determined whether the text message was sent with an acceptable syntax. In one embodiment, a mobile messaging platform capable of implementing the keyword functionalities is configured to process keyword queries only when a query conforms to a predetermined format. In another embodiment, a mobile messaging platform capable of implementing the keyword functionalities is configured to process keyword queries as long as a query conforms to one of several predetermined formats. The correctness of the message syntax can be determined with any convenient and/or known method including, but not limited to, parsing the message and analyzing components of the message in accordance to the predetermined formats.

Assuming the syntax is incorrect (504—NO), the flowchart 400 continues to module 516 where the user is notified that the keyword message was sent with an incorrect syntax. In one embodiment, the notification encourages the user to attempt another message using a correct syntax. In another embodiment, the notification encourages the user to visit a mobile messaging platform where the user can find reference information regarding keyword messaging syntax. A mobile messaging platform is any interface capable of implementing the keyword functionalities including, but not limited to, a web interface.

Assuming the syntax is correct (504—YES), the flowchart 500 continues at decision point 506 where it is determined whether a usage fee is associated with the keyword. A keyword owner may specify a usage fee such that anyone who queries the keyword must pay to receive the content associated with the keyword. In one embodiment, a keyword owner may allow others to subscribe to the keyword, retrieve the content associated with the keyword at any time, and charge the subscribers a usage fee at regular intervals. In another embodiment, a keyword owner may allow anyone a one-time access to the content associated with the keyword for a one-time usage fee.

Assuming the keyword is not associated with a usage fee (506—NO), the flowchart 500 continues at module 514 where the content for the keyword is sent to the user.

Assuming the keyword is associated with a usage fee (506—YES), the flowchart 500 continues at decision point 508 where it is determined whether the user has previously established any payment method. Checking whether the user has established a payment method can be facilitated using any convenient and/or known technique including, by way of example and not limitation, querying a database containing the credit card information associated with all registered users. In other embodiments, it can be determined whether the user has any other form of payment account on file including, by way of example and not limitation, a PayPal account and the like.

In the example of FIG. 5, if the user has at least one established payment method (508—Yes), the flowchart 500 continues at module 510 where the user is charged. In one embodiment where the user has established more than one payment method, the user is prompted to choose an established payment method or to establish a new payment method. In another embodiment, a default payment account that the user has on file is charged. Once the payment is verified, the flowchart 500 continues at module 514 where the content associated with the keyword is sent to the user.

In the example of FIG. 5, if the user does not have an established payment method (508—No), the flowchart 500 continues at module 512 where the user is prompted for payment in order to receive the content associated with the keyword. Once the user establishes a payment method and the payment is verified, the flowchart 500 continues at module 514 where the content associated with the keyword is sent to the user.

FIG. 5 is an illustrative embodiment and is not intended to be limiting, more or fewer steps may be included in alternative embodiments. In one embodiment, for example and not limitation, the keyword owner has chosen to restrict access to the keyword such that certain users may not obtain the content associated with the keyword, regardless of syntax and/or usage fees.

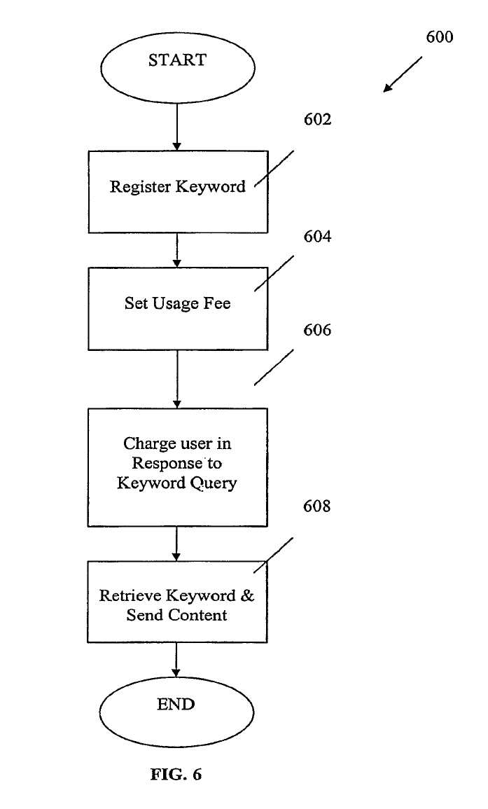

FIG. 6 depicts a flowchart 600 of an example of a method for sending content associated with a keyword. The flowchart 600 illustrates the functionality of a platform for setting up and sending content associated with a keyword to communication devices and charging a user for sending the content. The communication device may be any device capable of interacting with a system implementing the keyword functionality including, by way of example and not limitation, the Internet, mobile phones, PDAs, or IM clients. In the example of FIG. 6, the flowchart 600 begins at module 602 where a keyword is registered. The keyword can be registered using any convenient and/or known technique including, by way of example and not limitation, creating a keyword, reserving a keyword, bidding on a keyword, trading for a keyword, etc. Further, the keyword can be registered using any communication device including, but not limited to, the Internet, a mobile phone, a PDA, or an IM client.

In the example of FIG. 6, the flowchart 600 continues at module 604 where a usage fee is set. A keyword owner may specify a usage fee such that any user that queries the keyword must pay before the content associated with the keyword will be sent to the user. In one embodiment, a keyword owner may allow others to subscribe to the keyword, retrieve content associated with the keyword at any time, and charge the subscribers a usage fee at regular intervals. In another embodiment, a keyword owner may allow anyone a one-time access to the content of the keyword for a one-time usage fee. The usage fee can be set using any known and/or convenient technique, including, by way of example and not limitation, an Internet interface, a mobile interface, third party interface, and/or any other system capable of communication.

In the example of FIG. 6, the flowchart 600 continues at module 606 where the user is charged for a keyword query. The charge can be facilitated using any known and/or convenient technique, automatic or manual. For example, and not limitation, the user can be charged using a credit card saved on file, PayPal account, invoice, etc.

In the example of FIG. 6, the flowchart 600 continues at module 608 where the content associated with the keyword is provided to the user. In one embodiment, an SMS message response can be sent to the user's mobile phone. In another embodiment, additional delivery options can be utilized including, but not limited to, email, postal mail and/or any other service capable of communication. In other embodiments, the response may be sent to any communication device including, but not limited to, a PDA or an IM client. Although the example of FIG. 6 uses SMS messages, the system can be implemented with any known and/or convenient information and/or media that are deliverable to the user, including, by way of example and not limitation, songs, web pages, subscription information or the like.

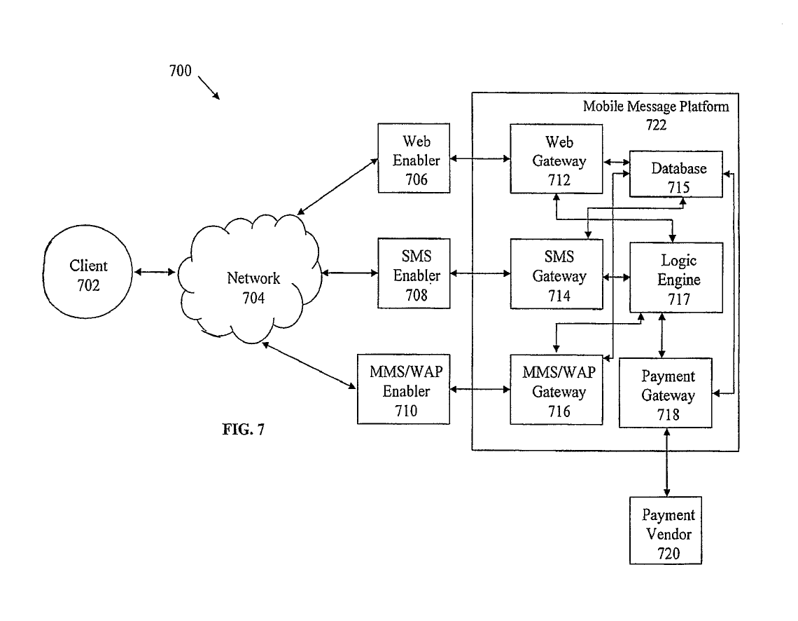

FIG. 7 provides an overview of a computer hardware embodiment suitable for performing the methods of the invention described herein, but is not intended to limit the applicable environments. Similarly, the computer hardware and other operating components may be suitable as part of the systems of the invention described herein. The invention can be practiced with other computer system configurations, including hand-held devices, multiprocessor systems, microprocessor-based on programmable consumer electronics, network PCs, minicomputers, mainframe computers, and the like.

FIG. 7 depicts a networked system 700 that includes a client device 702 coupled to a mobile message platform 722 through a network 704: In one embodiment, the client device is a computer system that accesses the mobile message platform 722 through a web interface and a network such as the Internet. The term “Internet” as used herein refers to a network of networks which uses certain web enablers 706, such as the TCP/IP protocol, and possibly other protocols such as the hypertext transfer protocol (HTTP) for hypertext markup language (HTML) documents that make up the World Wide Web. The physical connections of the Internet and the protocols and communication procedures of the Internet are well known to those of skill in the art. In an alternative embodiment, the client device is a mobile device such as a mobile phone or a PDA that accesses the mobile message platform 722 through a carrier network 704. Access to a carrier network is typically provided by well-established messaging infrastructure providers such as mBlox®. Further, a carrier network uses multimedia enablers 708 and 710 including the Short Message Peer to Peer (SMPP) protocol and other protocols such as the Wireless Application Protocol (WAP) and the Multimedia Messaging Service (MMS) to transfer media in various formats including text, images, audio, video, and the like. The physical connections of a carrier network and the protocols and communication procedures are well known to those of skill in the art.

In the example of FIG. 7, the mobile message platform 722 encompasses a number of gateways including a web gateway 712, a SMS gateway 714, and a MMS/WAP gateway 716 as entry points to platform 722 where a user may access keyword functionalities implemented on the platform 722. In the example of FIG. 7, the mobile message platform 722 further includes a payment gateway 718 where platform 722 can interface with payment vendors 720 such as PayPal to process user payment information. As shown in the example of FIG. 7, the gateways 712, 714, 716, and 718 are further connected to a database 715 and logic engine 717.

The logic engine 717 facilitates keyword functionalities such as keyword registration and subscription and, in one embodiment, may be implemented as computer software on one or more servers. The database 715 stores data including, but not limited to, user profile information, list of available and/or unavailable keywords, list of known trademarks, and the like. In one embodiment, the client 702 makes a query for information such as user profile to the database 715 via the network 704, an enabler (e.g. enabler 606, 608, 610), and a gateway (e.g. gateway 612, 614, 616). The database 715 receives the query and returns a result, if any, back to the client 702. The client 702 may make queries and receive results on any communication devices including, but not limited to, the Internet, a mobile phone, a PDA, or an IM client.

The example in FIG. 7 is illustrative and not limiting. One ordinarily skilled in the field will understand that a system suitable to carry out the methods of the invention may include additional and/or fewer components. For example, the database 715 may be a primary database coupled to one or more secondary databases where inserts and updates are received at the primary database and subsequently distributed among all the databases. An exhaustive list of all combinations and permutations of embodiments has not been attempted here but one skilled in the relevant art will recognize alternative embodiments based on the system described above.

As used herein, the term “embodiment” means an embodiment that serves to illustrate by way of example but not limitation.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

1. A system for providing user-generated content to communication devices, the system comprising:
a message platform, wherein the message platform being capable of receiving user-generated content from a remote source and associating the user-generated content with a keyword; and
a publishing module, wherein the publishing module being capable of receiving the keyword from a first communication device and providing the user-generated content to a second communication device.

2. A system as recited in claim 1, wherein the user-generated content is received as a text message.

3. A system as recited in claim 1, wherein the user-generated content is a type of format including at least one selected from the group consisting of text messages, graphics, video, audio, or emoticons.

4. A system as recited in claim 1, wherein the user-generated content is of a certain nature including at least one selected from the group consisting of advertising, coupons, or paid for content.

5. A system as recited in claim 1, wherein the remote source is a type of device including at least one selected from the group consisting of a computer system, a mobile phone, a PDA, or an IM client.

6. A system as recited in claim 1, wherein the first communication device and the second communication device are the same.

7. A system as recited in claim 6, wherein the communication device is a mobile phone.

8. A system as recited in claim 1, further comprising:
a log-in module for authenticating a user;
a content-editing tool for receiving and editing the user-generated content;
a database for storing one or more keywords and user-generated content associated with the keywords; and
a keyword-managing module for managing and associating at least one parameter to the keyword, the at least one parameter being capable of controlling certain attributes of the keyword.

9. A system as recited in claim 8, wherein the at least one parameter includes scheduling attributes, access attributes, and monetization attributes.

10. A system as recited in claim 1, further comprising:
a reservation module for checking the availability of the keyword and, if the keyword is available, allow a user to register as owner of the keyword.

11. A system as recited in claim 1, further comprising:
a monetization module that can monetize a user for utilizing the system.

12. A system as recited in claim 10, further comprising:
a monetization module that can monetize actions of a keyword owner.

13. A system as recited in claim 1, further comprising:
a monetization module that can monetize the act of providing the user-generated content.

14. A system as recited in claim 11 wherein the monetization module monetizes at least one selected from the group consisting of a keyword owner, the user, or a third party requesting user-generated content.

15. A system as recited in claim 1, wherein the message platform is instantiated as a process on the Internet.

16. A system as recited in claim 15, wherein the user-generated content and the associated keyword are integrated into a social networking site.

17. A method, comprising:
receiving a unique keyword from a first remote source;
retrieving user-generated content associated with the unique keyword; and
providing the user-generated content to a second remote source in response to receiving the keyword.

18. The method as recited in claim 17, wherein the keyword is received as a first text message.

19. A system as recited in claim 17, wherein the first remote source is a type of device including at least one selected from the group consisting of a computer system, a mobile phone, a PDA, or an IM client.

20. A system as recited in claim 17, wherein the second remote source is a type of device including at least one selected from the group consisting of a computer system, a mobile phone, a PDA, or an IM client.

21. The method as recited in claim 17, wherein the first remote source and the second remote source are the same device.

22. A method, comprising:
receiving a keyword request; and
determining whether the requested keyword is available,
if the keyword is not available, providing one or more alternatives,
if the keyword is available, initiating keyword registration.

23. The method as recited in claim 22, wherein the determining step further compromises performing a lookup in a database.

24. The method as recited in claim 22, wherein the one or more alternatives include suggestions of available keywords, a purchase option, a trade option, or a subscription option.

25. The method as recited in claim 22, wherein the keyword request is a registration request for a keyword.

26. The method as recited in claim 22, wherein the keyword request is a search request for a keyword.

27. A system, comprising:
means for receiving a unique keyword from a first remote source;
means for retrieving user-generated content associated with the keyword; and
means for providing the user-generated content to a second remote source in response to receiving the keyword.

28. The system as recited in claim 27, further comprising:
means for receiving user-generated content and associating the user-generated content with the keyword.

29. A system as recited in claim 27, wherein the first remote source is a type of device including at least one selected from the group consisting of a computer system, a mobile phone, a PDA, or an IM client.

30. A system as recited in claim 27, wherein the second remote source is a type of device including at least one selected from the group consisting of a computer system, a mobile phone, a PDA, or an IM client.

31. A computer-implemented business method for monetizing the provision of content to a user of a communication device, the method involving a content author associating specific content with keywords, the computer-implemented method comprising the improvement of providing the user of the communication device the specific content in response to the user of the communication device requesting the specific content through the keyword associated to the specific content.
